(19) United States
(12) Patent Application Publication
(10) Pub. No.: US 2024/0031401 A1
(43) Pub. Date: Jan. 25, 2024

(54) METHOD AND SYSTEM FOR ADVERSARIAL MALWARE THREAT PREVENTION AND ADVERSARIAL SAMPLE GENERATION

(71) Applicant: UNIVERSITY OF GUELPH, Guelph (CA)

(72) Inventors: Hamed HADDADPAJOUH, Guelph (CA); Ali DEHGHANTANHA, Guelph (CA)

(21) Appl. No.: 18/354,784

(22) Filed: Jul. 19, 2023

Related U.S. Application Data
(60) Provisional application No. 63/368,894, filed on Jul. 20, 2022.

(51) Int. Cl. H04L 9/40; H04L 41/16

(52) U.S. Cl. CPC H04L 63/145; H04L 41/16

(57) ABSTRACT

There is provided systems and methods for adversarial sample generation and adversarial malware threat prevention. The method including: receiving an input executable sample; extracting features of the input executable sample and applying feature mapping to determine components of the features; determining a binary classifier representing whether the executable sample is adversarial using one or more machine learning models, the one or more machine learning models taking the components as input, the one or more machine learning models trained using, at least, generated adversarial samples, generating the generated adversarial samples includes determining code caves in training executable samples and inserting generated payloads as benign samples at the determined code caves; and where the binary classifier indicates adversarial, dropping the input executable sample, otherwise outputting the input executable sample.

### FIELD OF THE INVENTION

The following relates generally to the malware prevention and detection, and more specifically to a method and system for adversarial malware threat prevention and adversarial sample generation.

### BACKGROUND OF THE INVENTION

The vast majority of computing devices are susceptible to malware. However, a specific segment of computing devices of concern are Internet-of-Things (IoT) devices. IoT devices are increasing in popularity, and many of these devices are able to install and run third-party applications. However, end-users of these devices are generally able to install and run their applications with no trustworthy defensive mechanism. This situation can lead to a wide range of potential security challenges. Adversaries are able to develop general and domain-specific malicious payloads for IoT devices.

### SUMMARY OF THE INVENTION

In an aspect, there is provided a computer-executed method for adversarial malware threat prevention, the method comprising: receiving an input executable sample; extracting features of the input executable sample and applying feature mapping to determine one or more components of the features; determining a binary classifier representing whether the executable sample is adversarial using one or more machine learning models, the one or more machine learning models taking the one or more components as input, the one or more machine learning models trained using, at least, generated adversarial samples, wherein generating the generated adversarial samples comprises determining code caves in training executable samples and inserting generated payloads as benign samples at the determined code caves; and where the binary classifier indicates adversarial, dropping the input executable sample, otherwise outputting the input executable sample.

In a particular case of the method, the binary classifier classifies the executable sample where a probability of being adversarial is above a defined threshold.

In another case of the method, the one or more machine learning models comprises a stack of machine learning models and wherein the probability of being adversarial is an aggregated probability of the outputs of the machine learning models in the stack of machine learning models.

In yet another case of the method, the defined threshold is a probability greater than 0.5.

In yet another case of the method, the method further comprising receiving a further input executable sample and, where the input executable sample was determining to the adversarial, comparing the input executable sample to the further input executable sample to determine if the further input executable sample is adversarial.

In yet another case of the method, determining the one or more components of the features comprises scoring features and determining a most prominent feature, and using the one or more components of the most prominent feature.

In yet another case of the method, determining the one or more components of the features comprises performing principal component analysis.

In another aspect, there is provided a system for adversarial malware threat prevention, the system comprising one or more processors and a data storage, the data storage comprising instructions for the one or more processors to execute: an input module to receive an input executable sample; an adversarial prevention module to extract features of the input executable sample and apply feature mapping to determine one or more components of the features, and to determine a binary classifier representing whether the executable sample is adversarial using one or more machine learning models, the one or more machine learning models taking the one or more components as input, the one or more machine learning models trained using, at least, generated adversarial samples, wherein generating the generated adversarial samples comprises determining code caves in training executable samples and inserting generated payloads as benign samples at the determined code caves; and an output module to output the input executable sample unless the binary classifier indicates adversarial.

In a particular case of the system, the binary classifier classifies the executable sample where a probability of being adversarial is above a defined threshold.

In another case of the system, the one or more machine learning models comprises a stack of machine learning models and wherein the probability of being adversarial is an aggregated probability of the outputs of the machine learning models in the stack of machine learning models.

In yet another case of the system, the input module receives a further input executable sample and, where the input executable sample was determining to the adversarial, the adversarial prevention module compares the input executable sample to the further input executable sample to determine if the further input executable sample is adversarial.

In yet another case of the system, determining the one or more components of the features comprises scoring features and determining a most prominent feature, and using the one or more components of the most prominent feature.

In yet another case of the system, determining the one or more components of the features comprises performing principal component analysis.

In another aspect, there is provided a computer-executed method for adversarial sample generation, the method comprising: receiving an executable sample; generating executable segments from the executable sample; determining one or more code caves as sparse spaces in the executable segments; generating payloads based on patterns in the executable segments; inserting the payloads into at least one of the code caves of the executable sample; outputting the executable sample with the inserted payloads.

In a particular case of the method, generating the executable segments comprises performing a chunking function.

In another case of the method, the executable segments are in bytecode.

In yet another case of the method, generating the payloads comprises inputting the executable segments into a generative machine learning model, the generative machine learning model trained using bytecode segments of malicious and benign samples.

In yet another case of the method, the executable segments substantially comprise ‘.data’ segments.

In yet another case of the method, the method further comprising iteratively performing receiving the executable sample, generating the executable segments, determining the one or more code caves, generating the payloads, and inserting the payloads, wherein the payloads are inserted in different code caves than those that received payloads in a previous iteration.

In yet another case of the method, determining the one or more code caves comprises sparse spaces that are greater than a predetermined size.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a schematic diagram of a system for adversarial sample generation and adversarial malware threat prevention, according to an embodiment;

FIG. 2 is a schematic diagram showing the system of FIG. 1 and an exemplary operating environment;

FIG. 3 is a flowchart of a method for adversarial sample generation, according to an embodiment;

FIG. 4 is a flowchart of a method for adversarial malware prevention, according to an embodiment;

FIG. 5 is an example illustrating application of Principal Component Analysis (PCA) to score and determine a most prominent feature;

FIG. 6 illustrates a diagram of an example of decision making for adversarial prevention;

FIG. 7 illustrates an example of the stack of ML engines aggregating an output decision on an incoming sample;

FIG. 8 illustrates an example diagram of an implementation of a firewall for malware threat detection;

FIG. 9 is a diagram showing an example approach for an adversarial prevention module, trained with non-adversarial samples and adversarial samples, to identify adversarial samples from legitimate executable samples based on feature characteristics, in accordance with the method of FIG. 4;

FIGS. 10A to 10D illustrate example outputs illustrating differences in generated samples, adversarial and non-adversarial, for example experiments;

FIG. 11 illustrates PCA scores for sample features based on their labels for the example experiments;

FIGS. 12A to 12D illustrate an example of eight features from feature analysis evaluation in the example experiments;

FIG. 13 illustrates an example of prominent features outputted in the example experiments;

FIG. 14 illustrates an example of PCA scores for a top ten of the features, based on their labels, for the example experiments;

FIG. 15 illustrates PCA values for the dataset samples, represented by divergent bar charts for the adversarial and non-adversarial samples, for the example experiments; and

FIGS. 16A and 16B illustrate charts from the example experiments showing an example of one prominent feature class that PCA cannot differentiate but MMD can differentiate.

Like reference numerals indicated like or corresponding elements in the drawings.

### DETAILED DESCRIPTION OF THE EMBODIMENTS

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to the malware prevention and detection, and more specifically to a method and system for adversarial malware threat prevention and adversarial sample generation.

Malware threats are a significant challenge in every IT-based infrastructure. With increasing IoT applications in different domains, malware threats significantly affect IoT-based infrastructures as well. IoT infrastructures are usually categorized into a three-layer architecture: (1) application, (2) network, and (3) edge-layer (perceptional layer). Malicious actors usually develop malicious payloads for the edge layer and application layer. The edge-layer faces a wide range of attacks due to the accessibility of its nodes in the end-user environment (for example, Mirai attacks).

Machine learning-based approaches can be used for malware threat prevention, hunting, and attribution. While the use of end-to-end deep learning makes it easy to create new models for a variety of file types by simply exploiting the vast number of labeled samples available to such organizations, it also opens up the possibility of attacking these models using adversarial evasion techniques; such as those popularized in the image classification space. Various machine learning models, such as Support Vector Machine (SVM), Deep Neural Networks (DNNs), and other distant-based learning approaches, are vulnerable to Adversarial Examples (AEs). An adversarial example includes perturbations in a malicious or wrong label sample's feature vector to fool a classifier.

Generally, DNN classifiers have vulnerabilities, such as those exploiting their structures to fool the classifiers and countermeasures. For example, in the image classification environments, an adversarial attack on a classifier perturbs a sample so that it is no different to a human but wrongly classified by the target classifier. Since image, text, and audio classifiers deal with continuous features and there is no contextual constraint for generating adversarial examples (AEs), they can be fooled most easily. However, unlike image, text, and audio environments, there are some contextual constraints for fooling malware threat hunting models. Most ML-based malware threat hunting models work with binary feature values (0,1) inputs. In some cases, malware AEs not only fool malware detection models but also preserve at least some functionality of the generated sample as an actual executable. Therefore, the firm semantics of binary files prevent any arbitrary perturbations in the value of the features.

In some cases, attacks can exploit existing shortcomings of ML-based prevention models based on their decision boundaries. However, these boundaries cannot be altered deliberately and need a precise effort to preserve the functionality of a generated example. For example, techniques based on modifying byte features and metadata of the executable file to attack gradient boosted decision trees threat hunting model. Also, attack models against Malconv, a well-known malware threat hunting model, via editing padding bytes of executable based on gradient-driven approach. Therefore, the implication is that most ML-based threat hunting models are vulnerable against adversarial gradient-based attacks.

Adversarial attacks on malware threat hunting models typically apply random perturbation on different properties of executable files, like header files, despite their success rates. However, there is no certain procedure to define the attack surface of executable files, for example in IoT environments. In some cases, an attack surface in IoT malware executable files based on code-caves in bytecode can be performed and these spaces can be exploited for bypassing conventional malware threat hunting models. As described herein, these attacks can then be used to train adversarial prevention approaches.

The adversarial machine learning attack was generally first introduced for image based classifiers. It can be presumed that ƒ is a target model (classifier) that an adversary tries to attack. For better understanding, let us assume that function ƒ(.) takes input and assigns a label to it. Therefore, an AE x′ targeting ƒvia perturbing an original input of x with δ so that ƒ(x)≈ƒ(x′).

x′=x+δ

ƒ(x)≈ƒ(x′)

There are different ways to find the appropriate δ, for example, a Fast Gradient Sign Method and Carlini-Wagner (C&W) attack. Most attacks use the gradient of the loss function by considering the input to find the best direction for perturbing the input sample to flip the output label. The direction then used to find the δ.

Attack surface is the access of the adversaries/threat actors to the target model, includes input and output of the ML model which plans to attack. However, this access is limited to the threat actors' knowledge and capabilities. The threat actors' knowledge represents the amount of information that they can have regarding the target model. In adversarial ML, this knowledge can be categorized into two major groups called white-box and black-box models.

In the white-box model, the adversary presumes to have complete information about the target model such as model weight and parameters, as well as the trained data used during the training phase. In contrast, in black-box models, the threat actors only have access to the input and output of the target model.

Conventionally, adversarial example efforts are conducted using image datasets, such as MINIST, ImageNet, and CIFAR10. Therefore, in the malware threat hunting domain, most adversarial approaches are also conducted on image-based malware threat hunting models. In these approaches, malware properties mapped into images and then classified by image-based classifiers. Although these efforts can be adopted in real-world systems, they cause conversion overhead which made them impractical for certain examples, such as in IoT environments.

Adversarial machine learning attacks against malware threat hunting approaches which can preserve the binaries' functionalities can be divided into the following example categories:
Modifying the import table by adding functions name;
Altering the binaries section names;
Removing the signer names or change the signer name;
Creating the new section names (unused);
Changing debugging data;
Inserting/copying bytes to unused space in sections;
Manipulating the binaries header information; and
Obfuscating the binaries by wrapping/unpacking techniques.

Since most of the above techniques need manual procedures, adversarial machine learning approaches can not be applied. However, by applying advanced ML techniques, like Reinforcement Learning (RL), some of them could generate the AEs while preserving the binaries' functionalities.

A wide range of conventional machine learning and DNN approaches for malware threat hunting focus on manual feature modification that are extracted from executable files, like registered signatures and API calls. For this kind of hunting approach, it is mainly based on the manual features which are supposed to be used by the defensive mechanism.

Some approaches use application programming interfaces (APIs) and system calls as binary features and apply deep learning models to generate adversarial examples. Other approaches are based on API call sequences applied and an optimization process to run adversarial attacks. In other cases, generative adversarial networks (GANs) are widely used in computer vision tasks which can be applied for adversarial malware threat hunting models.

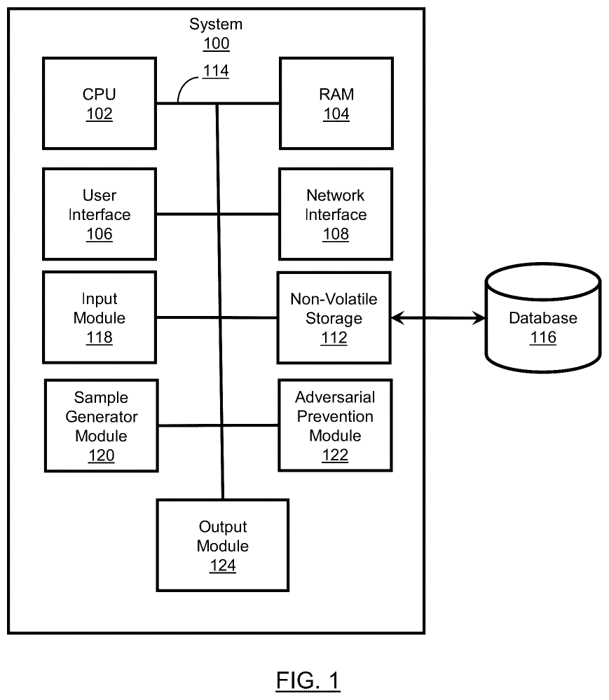

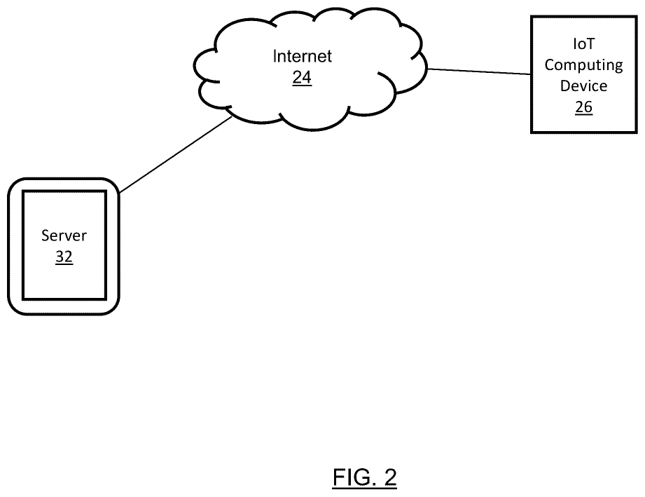

Referring now to FIG. 1, a system 100 for adversarial sample generation and adversarial malware threat prevention, in accordance with an embodiment, is shown. In this embodiment, the system 100 is run on a local computing device (such as IoT device in FIG. 2). In further embodiments, the local computing device can have access to content located on a server (in FIG. 2) over a network, such as the internet (in FIG. 2). In further embodiments, the system 100 can be run on any suitable computing device; for example, the server (in FIG. 2).

In some embodiments, the components of the system 100 are stored by and executed on a single computer system. In other embodiments, the components of the system 100 are distributed among two or more computer systems that may be locally or remotely distributed.

FIG. 1 shows various physical and logical components of an embodiment of the system 100. As shown, the system 100 has a number of physical and logical components, including a processing unit (“CPU”) 102 (comprising one or more processors), random access memory (“RAM”) 104, a user interface 106, a network interface 108, non-volatile storage 112, and a local bus 114 enabling CPU 102 to communicate with the other components. CPU 102 executes an operating system, and various modules, as described below in greater detail. RAM 104 provides relatively responsive volatile storage to CPU 102. The user interface 106 enables an administrator or user to provide input via an input device, for example a keyboard and mouse. The user interface 106 can also output information to output devices to the user, such as a display and/or speakers. The network interface 108 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data can be stored in a database 116, such as the data in the databases described herein (adversarial samples database, adversarial signatures database). During operation of the system 100, the operating system, the modules, and the related data may be retrieved from the non-volatile storage 112 and placed in RAM 104 to facilitate execution.

In an embodiment, the system 100 further includes a number of functional modules that can be executed on the CPU 102; for example, an input module 118, a sample generator module 120, an adversarial prevention module 122, and an output module 124. In some cases, the functions and/or operations of the modules can be combined or executed on other modules.

The system 100 provides a type of anti-baffling for an artificial intelligence (AI)-type firewall for that can detect malware. The system 100 includes two overarching aspects: adversarial malware threat prevention performed by the adversarial prevention module 122 and adversarial sample generation performed by the sample generator module 120. In particular cases, the system 100 can be deployed, or otherwise executed, as a firewall for any platform that works with executable files.

To maximize security, each incoming executable file should be validated in terms of whether it is a legitimate executable file or it is an adversarial sample; for example, a sample generated by an AI engine designed to fool anti-malware detection. These kinds of samples can be the most dangerous types of attacks that can fool AI-powered malware detector engines. Advantageously, the system 100 can identify adversarial executable samples that are weaponized by inserted payloads in their bytecode segments and then drop them from further processing. By applying machine learning-based malware threat detection, the system 100 can robustly preserve the device from harm caused by adversarial malware threats.

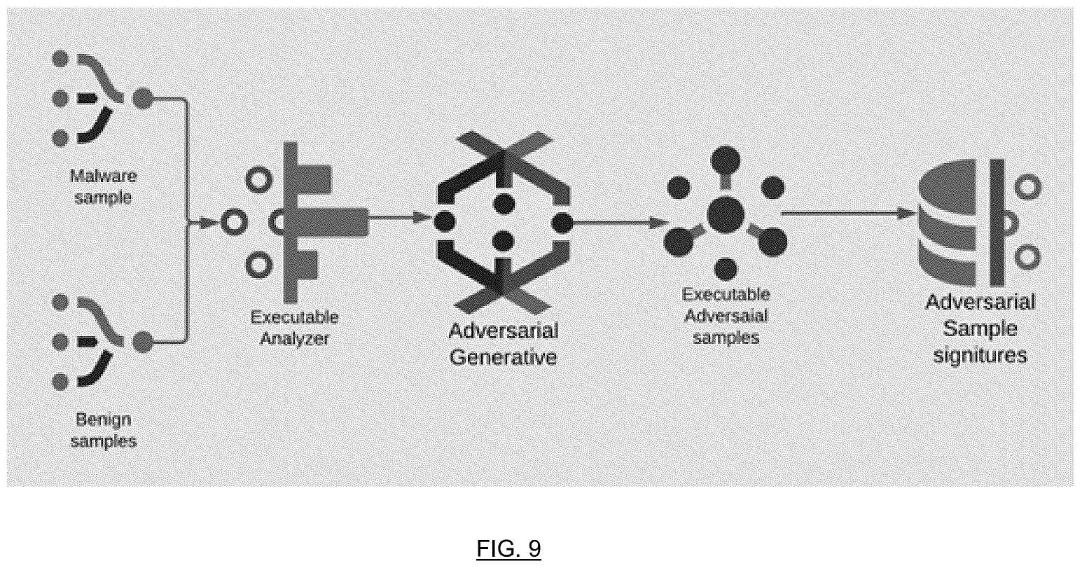

As illustrated in the example of FIG. 9, the adversarial prevention module 122, which is trained with non-adversarial samples and adversarial samples, can be used to identify adversarial samples from legitimate executable samples based on feature characteristics. Moreover, the adversarial prevention module 122 can be used to match previous adversarial examples with incoming executable files as a signature-based approach.

Sources of detection for the adversarial prevention module 122 can use adversarial samples determined by the sample generator module 120. The sample generator module 120 generates different possible variants of adversarial malicious samples based on gradient-based attacks on perturbing bytecode properties of malware datasets. The signatures of these samples can be stored in an adversarial sample database on the database 116. The sample generator module 120 can take as input an external dataset to generate a variant type of adversarial samples that are versions of legitimate samples. In this way, the sample generator module 120 can generate a good knowledgebase for incoming attacks.

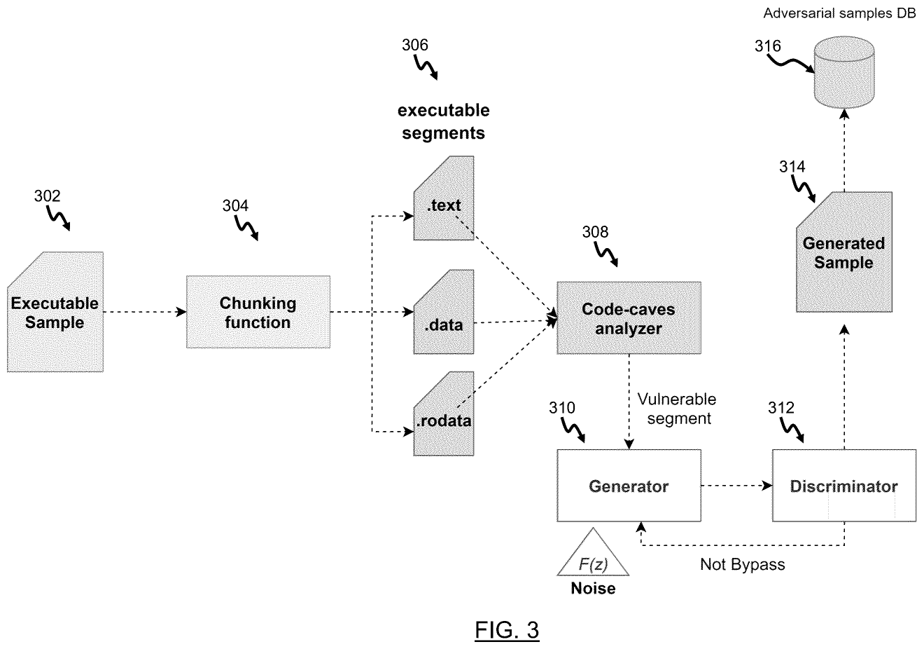

FIG. 3 illustrates a flowchart diagram of a method for adversarial sample generation 300, according to an embodiment. The method 300 locates vulnerabilities in different segments of executable files by segment parsing and sample generation in order to generate simulated executable samples. These simulated executable samples are designed to evade conventional targeted malware detector engines.

At block 302, an executable sample is received by the input module 118 and, at block 304, the sample generator module 120 performs a chunking function to generate executable segments (also referred to as subsections); as illustrated at block 306. The chunking function takes an executable file and breaks to subsections. In a particular case, the subsections can be .data, .rodata, and .header (or .text) segments. In some cases, not all subsections comprise bytecodes, and in such cases, the chucking function can convert the non-bytecode data into a bytecode equivalent.

At block 308, the sample generator module 120 analyzes each segment for any code caves; as a potentially vulnerable location for finding attack surfaces to inject adversarial payloads (i.e., weaponized). This analysis returns information on vulnerable locations to be used by a generative model for experimenting with the evasion rates.

The sample generator module 120 can locate code caves using a function that analyzes each given input bytecode in order to scan for spare spaces and flag them as a code cave. For example, by (1) finding sparse spaces in incoming samples bytecode segments (text, data, rodata), and (2) assessing the size and number of such sparse spaces. In an example, a code cave should only be flagged if it is greater than a given size (e.g., should be more than 250 bytes) because it would be the least amount of space required for inserting meaningful generated payloads by the generative model.

Generally, generative adversarial models are a type of machine learning model that mimic sample generation based on real-world datasets distributions. In the present case, such models can be used to generate legitimate executable files (Bytecodes) based on a real-world dataset. These models can be trained based on a discriminative model, which are ground-true classifiers. In the present case, a justified classifier, MalConv, can be used to generate adversarial examples. The input features of the generative model can be raw sample features with noise.

The sample generator module 120 can use two different models for generating samples; a name generator 310 and a discriminator 312. The sample generator module 120 can use the information regarding potentially vulnerable locations to attack targeted threat AI engines by inserting noise information. ‘Nonsense’ noise information can be generated based on gradient descent vulnerability on artificial intelligence (AI) engines. The sample generator module 120 can also use different parameters based upon installed environments and imported executables files (such as payload generation size and segment insertion). In an example, such parameters can include training batch size, epoch (number of iterations for training), number of input features (embedding windows); in an example, Malconv can be used with an input size of 1 MB raw bytecode, one embedding and two 1D convolutional layers with binary cross entropy as a final classifier.

Moreover, the sample generator module 120 can store deployed environment AI agents' hyper-parameters in a parameters database to generate adversarial attacks in a white-box approach. The hyper-parameters are generally related to a target model for generating adversarial examples in adversarial learning. These hyper-parameters can include, for example: training batch size, number training epochs, embedding size, model architecture (e.g., number of applied units, connection type (directional, bi-directional), optimization type, activation function, and the like).

In an example, sample generator module 120 can use two approaches to generate adversarial examples for an adversarial model: FGSM and Projected Gradient Descent (PGD). FGSM attack is a white-box attack with the goal of misclassification. Generally, artificial neural network models use gradients to learn features of a given dataset, where they adjust their weight in each iteration by backpropagating gradients to minimize a loss function. With FGSM, instead of minimizing the loss function to reach best possible solution, it adjusts the input data with respect to some given noise. In this way, such approach uses gradient loss on input data, and then adjusts the input to maximize the loss function. This approach is used by the sample generator module 120 to add noise to the input data (i.e., a malicious sample) and fool the target model (e.g., MalConv).

In some cases, the model generative model used by the sample generator module 120 can be replaced with any suitable model; for example, using a MalConv model.

At block 310, the sample generator module 120 uses the generator 310 to generate appropriate payloads (generated samples) based on the information on vulnerable segments from the analyzer function. The discriminator 312 of the sample generator module 120 uses these payloads to attack a targeted AI engine until it bypasses the engine. Then, the sample generator module 120 inserts the generated payload as a benign sample for a generated sample 314. In a particular case, a gradient base adversarial attack method, called Fast Gradient Sign Method (FGSM), can be used to find potentially vulnerable locations in the Malconv model.

Since the target model (e.g., MalConv) accepts raw bytecode as input, the sample generator module 120 can generate byte-level adversarial examples to bypass the target model. Based on knowledge about the target model and the structure of a benign sample pattern generative model, the sample generator module 120 generates a meaningful bytecode and inserts byte level data (i.e., mimicking a byte level of benign samples in the training dataset) into the code cave spaces to bypass the target model. Knowledge about the target model can include the hyper parameters (e.g., input size, convolutional layers, activation function, and number of learning features) of the target model (Malconv). Due to the fact that the generative model is operating as a ‘white-box attack’, the target model is known for the generation of the adversarial example.

The generative model generates payloads based on bytecode segment patterns of benign samples in the given training dataset to insert into malicious sparse code cave spaces. The generative model can learn the bytecodes of malicious and benign samples from the training dataset. Where the training dataset can include bytecode segments of samples (e.g., in .text, .rodata, and .data data types). In most cases, the generative model can focus on the .data segment; which is the part of the bytecode that can be modified without changing the functionality of the executable file (i.e., is still able to be executed). Therefore, the generative model tries to generate a sequence of bytecodes that are similar to benign samples (.data segment) with a fixed size (e.g., 256 bytes), as a least meaningful sequence, to be a payload for injecting into malicious code-caves spaces.

Generation of adversarial examples, in some cases, can be iterative. In an example, finding code-cave spaces in the malicious sample, generating the payload, inserting the payload, and flipping the class label of the generated sample can be iterative. With each iteration, in some cases, a payload is generated and inserted into a detected code cave and communicated to the targeted model (Malconv). The generative model may attempt to insert a previously generated payload into a different code-cave address. In some cases, the iterations can be performed until a label of the payload flips for the malicious sample from malicious to benign. The final adversarial example will generally be a malicious sample that includes inserted adversarial payloads in its code cave and could bypass the target model by assigning it a benign sample.

At block 316, the successful adversarial samples can be stored in a separate adversarial samples database for training the adversarial prevention module 122; acting as an internal system repository. In some cases, this database can be updated from internal and/or external models/repositories.

Most executable files include distinct parts, such as a header that contains primitive information about the entire executable file, and after the header, several executable sections. Each section of executable files contains a requirement for executing the file. In an example, cloud-edge devices in an IoT environment also use Linux ELF files for their operations. Therefore, these files can be defined by three executable sections, namely: .text, .data, and .rodata (includes executable instruction, needed data, and read-only data respectively).

One of the evasion techniques for bypassing defensive mechanisms against malware threats is by exploiting free spaces in executable files; so-called ‘Code-caves’. Code-caves are series of unused bytes in the process memory of the victim's system. Malicious actors exploit these unused bytes to inject their malicious payloads into the benign files. This vulnerability was used by the present inventors for generating adversarial examples. In an example experiment, an IoT dataset was used that included over 550 samples collected from a cloud-edge device in IoT environments.

Preserving functionality (x′=x+δ) is a substantial challenge in generating adversarial examples. Therefore, perturbation is to be minimized to preserve the functionality of the generated samples while maximizing the evasion rate. In order to achieve preserve the functionality of generated samples, in the case of IoT environments, the .textsection of the ELF files cannot be used because each modification in instructions of an executable file may lead to corruption of its functionality. Due to the lack of modification permission in the .rodata section of the executable file, malicious payload can be generated and inserted in code-caves of this section. Therefore, the .data section is also suitable for generating the adversarial examples.

In example experiments, the Malconv model was used as a target model. Malconv is a convolutional neural network model that was developed to detect malicious executable files via their bytecodes. To obtain the mentioned objective, a paradigm was designed by the present inventors. As illustrated in FIG. 3, the example experiments consisted of three main sections for generating the adversarial examples. Input samples are pre-processed by extracting the segments of each input sample and using them for vulnerability analysis. In a particular case, the code-caves region can be determined and related information associated with the defined section can be extracted. As illustrated in the example of TABLE 1, in an example, the size, entry point address, and endpoint address of each code-cave in each extracted section can be stored.

TABLE 1

| | | | | Virtual |
|---|---|---|---|---|
| Section name | Cave begin | Cave end | Cave size | Address |
| .data | 90735-0x1626f | 90985-0x16369 | 250 bytes | 0x2626f |
| .rodata | 60048-0xea90 | 60316-0xeb9c | 268 bytes | 0x16a90 |

In order to evaluate the approach of method 300, the example experiments included different types of adversarial attacks against the targeted model to generate the adversarial examples to bypass the Malcov model as the target model.

ML models, like the targeted model (Malconv), generally try to minimize the cost functions using the gradient descent algorithm. Thus, The FGSM attack tries to find an adversarial direction, and all bytecode values change based on that direction in an attempt to lead to fool the classifier and cause misclassification. Adding imperceptibly small computed noise in the same direction of the cost function is able to maximize the cost function instead of minimizing it. In this way, attackers can use the gradient cost function with respect to input data and add a small amount of perturbation to maximize the cost. By doing this, attackers can craft adversarial samples which are assigned to incorrect labels. Malware threat attacks based on FGSM attack can be defined as follows:

max C(M,x′,y) (1)

subject to x′=x+δx (2)

|x|_{d}≤ϵ*|x| (3)

δx=ϵ*sign(∇xC(M,x′,y)) (4)

Equation (3) indicates that any dimensions allow being altered, although the number of dimensions should not differ from original samples. Moreover, the goal of maximizing the error in Equation (1) can occur due to misclassification of the model based on the computed ox. This value also reaches as Equation (4). Where the sign(∇xC(M,x′,y)) is the direction of a minimized cost function that corresponds to δx value from Equation (4). Thus, the cost function of adversarial malicious payloads is C(M,x′,y) where y≈y.

In the example experiments, after getting desired information for each segment of the benign sample, the code-cave space is evaluated to exploit them for generating malicious examples. ALGORITHM 1 demonstrates an example of corresponding pseudo code. In an example, there are three major inputs; the original sample batch size, associated code-caves information, and target model. The model generates a random adversarial payload based on Equation (4) to find an appropriate 6. To preserve the functionality of AEs, unlike image-based models, code-caves are used and a certain payload size is injected into the input sample; then it is passed to the model again for final classification. This iterative procedure continues until an evasion threshold is satisfied (e.g., T>0.5).

ALGORITHM 1

```
function (x, Codecsave, model)
  while !evade do
    payload := generator(x, p = 1) w.r.t Equation (4)
    x′:= inject (payload; x, Codecave)
    probability = model:predict (x′)
    if probability > T then
      label := benign
      evade := True
        return x′
```

The example experiments used Mean Square Error (MSE) as the target model's loss function to compute the gradient of model output:

$$M S E = \frac{1}{n} {Σ}_{t = 1}^{n} {e}_{t}^{2} .$$

In this equation, n is the number of data point, and e²=(yᵢ−y′ᵢ)², where yᵢ is observed value and y′ᵢ is predicted value.

In one of the example experiments, a decision boundary of the Malconv model was defined with a different segment for each dataset sample. As can be seen in TABLE 2, each malware segment from an IoT dataset was evaluated to find a weakest part of the IoT executable file. As shown, the .data segment is the best fit for generating the adversarial example for a deep malware threat hunting model like Malconv.

TABLE 2

| section name | recall |
|---|---|
| .text | 0.98 |
| .data | 0.48 |
| .rodata | 0.99 |

The example experiments applied the IoT dataset to train the target model for the primitives hunting for whole executable files. A splitting technique (70-30) was used for testing the Malconv model by the IoT dataset. Thus, the trained model could hunt malicious payload with over 99% detection accuracy. After training the target model, AEs were generated to attack the target model. In this example, AE was defined as x′ and was generated by introducing a narrow change to an original input sample x with x′=x+δ. For generating the adversarial payloads, the attack model was configured to generate the best variant of the bytecodes from test data for injection. To generate the adversarial example, a Cleverhans toolkit was used to implement the attack model based on FGSM.

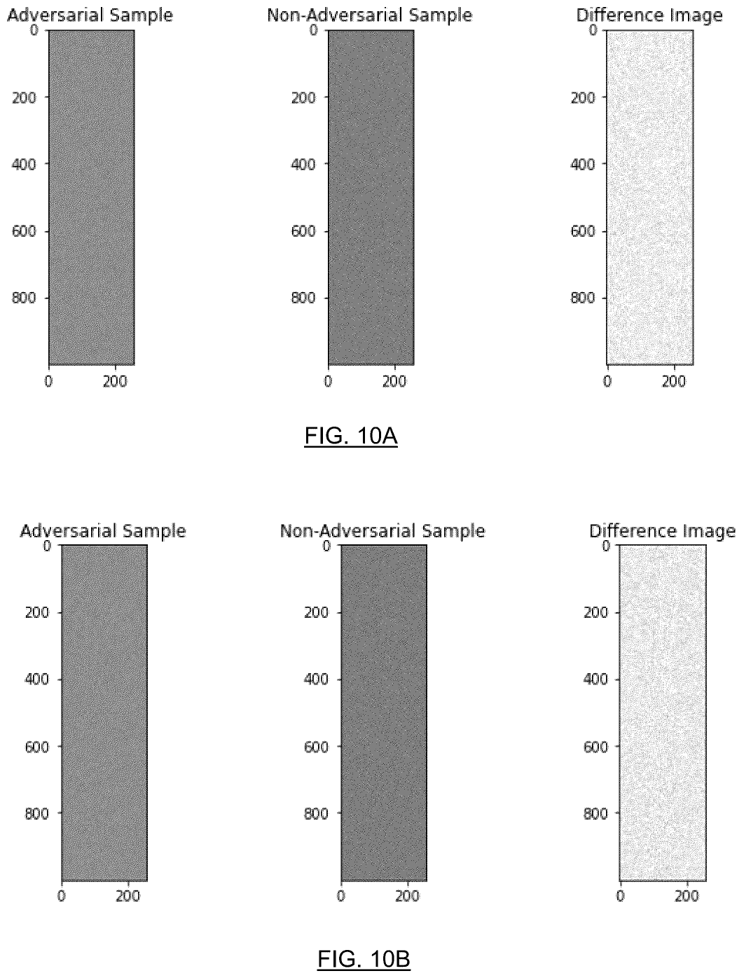

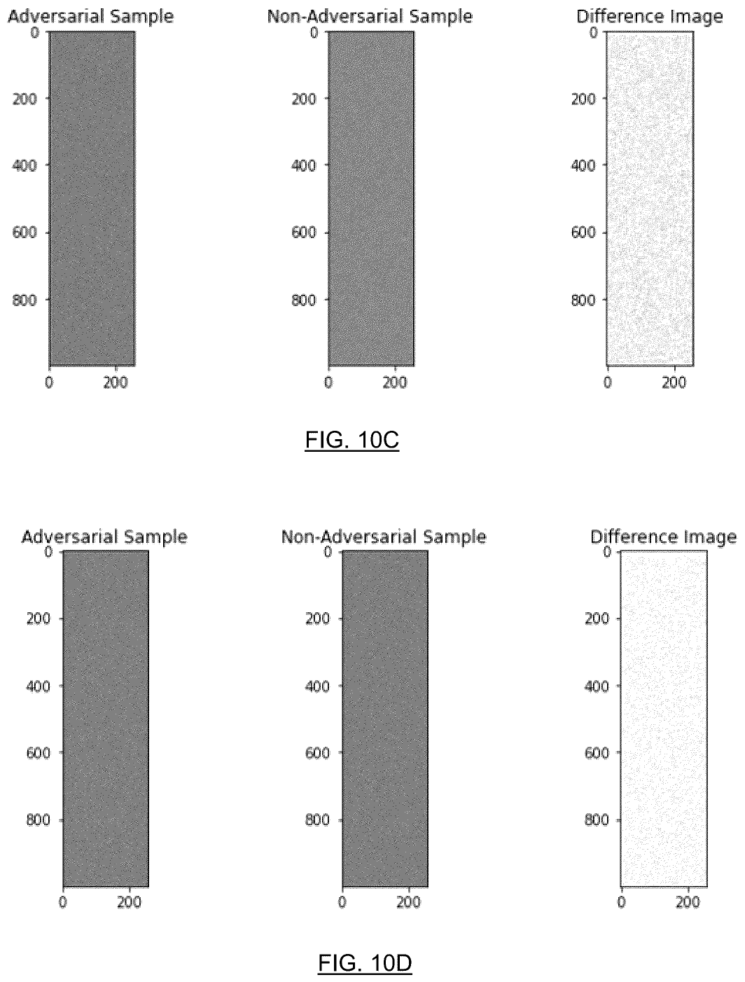

FIGS. 10A to 10D illustrate differences in generated samples, adversarial and non-adversarial, for the example experiments.

After the evaluated samples were generated in the example experiments using Malconv, both target threat hunting models (Malconv and the proposed Multi-kernel) were attacked. TABLE 3 shows evasion rate information of the proposed attack model by FGSM. As TABLE 3 indicates, Malconv, and the proposed multi-kernel models, could be evaded by injecting adversarial payloads into IoT executable files.

TABLE 3

| | evaluation | detection | |
|---|---|---|---|
| target model | method | accuracy | evasion rate |
| Malconv | x-val | 98% | 16% |
| Multi-kernel | x-val | 99% | 24% |

The example experiments illustrate that the method 300 generates adversarial samples that can be used as a realistic attack against robust ML threat hunting models. As described, these types of generated adversarial samples generated by the method 300 can be used to train robust models for for adversarial malware prevention.

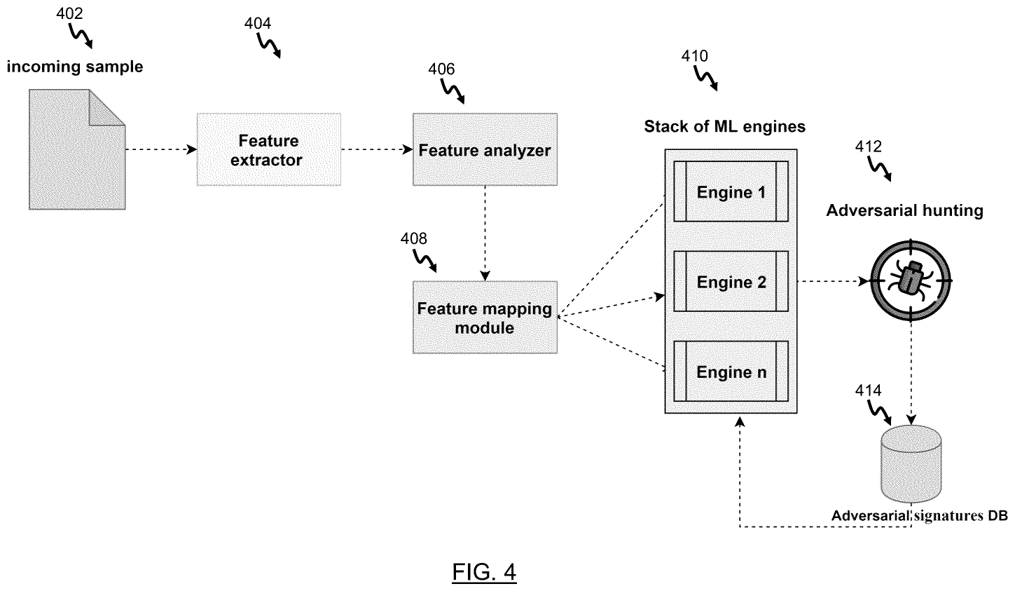

FIG. 4 illustrates a flowchart diagram of a method for adversarial malware prevention 400, according to an embodiment. The adversarial prevention module 122 strives to preserve the robustness of the framework while generating a signature of detected adversarial samples based on their features' characteristics for AI-powered malware detection engines. The adversarial prevention module 122 can perform sample analysis and signature generation; see FIGS. 10A to 10D for an illustrative example.

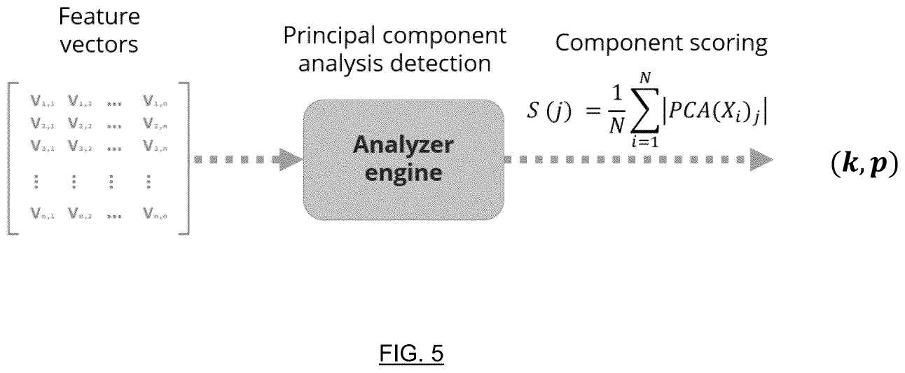

At block 402, an incoming sample is received by the adversarial prevention module 122. The sample analyzer of the adversarial prevention module 122 extracts features of the sample (at block 404) and analyzes such features (at block 406) to determine feature vector characteristics that can be used to find potential fake benign samples that target the AI engines. The adversarial prevention module 122 can use dimensionality analysis and density characters, learned from legitimate malicious and benign samples, to detect the adversarial samples. In a particular case, at block 408, feature mapping can apply Principal Component Analysis (PCA) to score and determine a most prominent feature; as illustrated in FIG. 5. By using principal component analysis, each sample deconstructs into its eigenvectors and values, such that the most effective component of the dominant class can be identified as model output. The output of the sample analyzer is a tuple of (k, p); where k is a number component and p is a probability of a classifier M. In an example, the sample analyzer can identify the most prominent component of an incoming sample using:

```
function PCA ANALYZER (X, M)
  n := min (x)
  c* := arg max M (X)
  for k = n to 1 do
    Compute X_{K} ← PCA (X)
    Compute c ← arg max M (X_{K})
    if c ≠ c* then
      return c.
    else
      return c*.
return The (k, p) point of X with respect to classifier M
```

In most cases, the extracted features are a sequence of binary 0's and 1's that represent bytecodes in the sample. Each bytecode can be represented by a hexadecimal value and the hexadecimal values can be sorted according to highest PCA score. The extracted features are extracted bytecodes of the incoming samples. Each sample can be converted to a fixed length feature vector by an embedding layer, where each feature vector is a dense array having real values instead of binary 0's and 1's. The feature vector characteristics can include incoming samples feature value patterns, such as, density, sparsity or even zero/missing value.

The dimensionality analysis can be any suitable PCA scoring approach and density characters can be any suitable approach for assessing density of feature values in each class (benign, malware); for example, using a Maximum Mean Discrepancy test. In most cases, components can refer to eigen vectors and eigen values of features vectors (e.g., .byte segments of executable files) that are obtained by dimension decomposition in PCA. In a particular case, bytecodes of executable files are extracted and then mapped to feature vectors for feature analysis, as described herein.

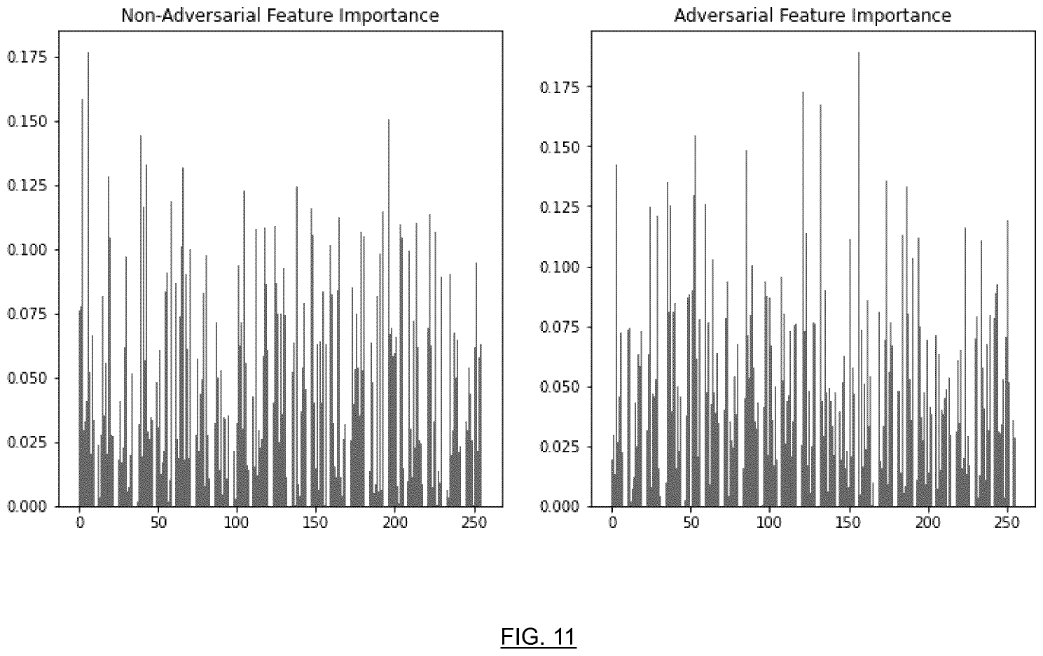

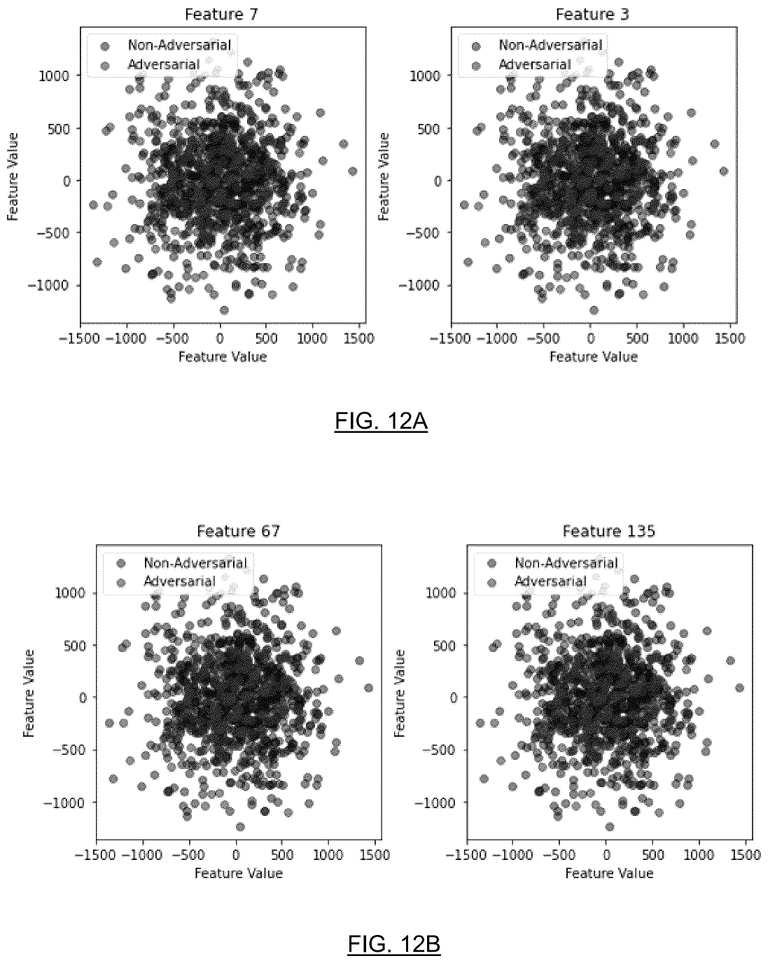

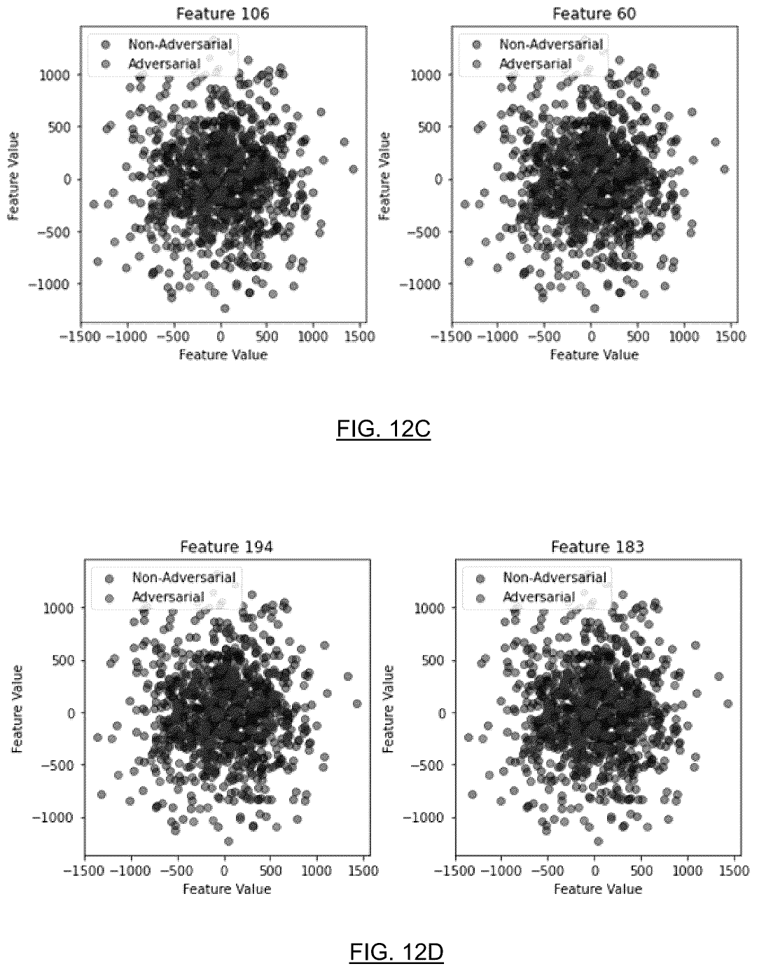

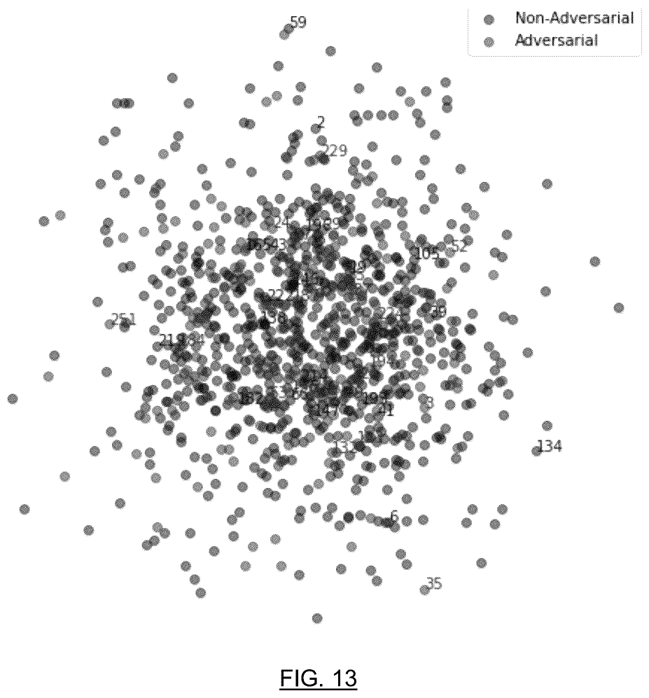

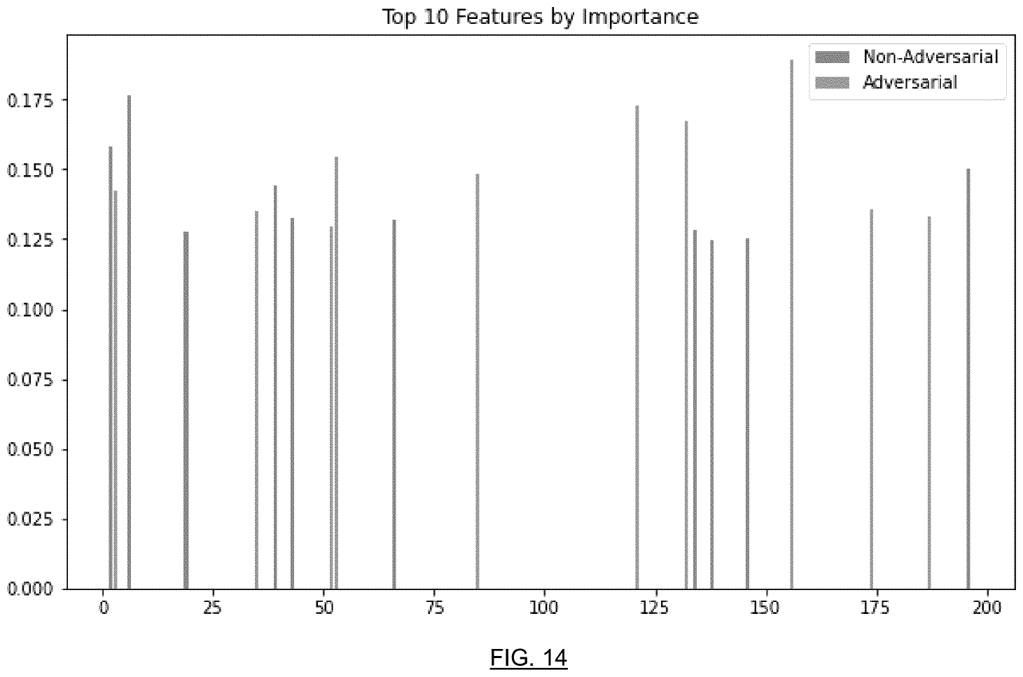

FIG. 11 illustrates the samples' features PCA scores based on their labels for the example experiments. FIGS. 12A to 12D illustrate an example of eight features from feature analysis evaluation results in the example experiments and FIG. 13 illustrates an example of the prominent features. FIG. 14 illustrates an example of the top ten features PCA scores based on their labels.

In addition, to using feature characteristics, the sample analyzer can use the adversarial samples database 316 to detect adversarial samples by their features signatures. In a particular case, the incoming samples are first decomposed into their bytecodes and their feature vectors are extracted by: converting each sample into bytecode segments, converting each bytecode segment into a sequence of bytecode values (e.g., 0-255), and converting each segment of bytecode values into a fixed length feature vector by a suitable embedding technique. These feature vectors can be scored based on PCA and Maximum Density Divergence (MDD) can, in some cases, be applied.

In some cases, the present embodiments can be used for detection of adversarial attacks on Internet of Things (IoT) devices. The Maximum Mean Discrepancy (MMD) can be utilized to examine the density distribution of the principal feature components; applicable to both adversarial and non-adversarial executable files.

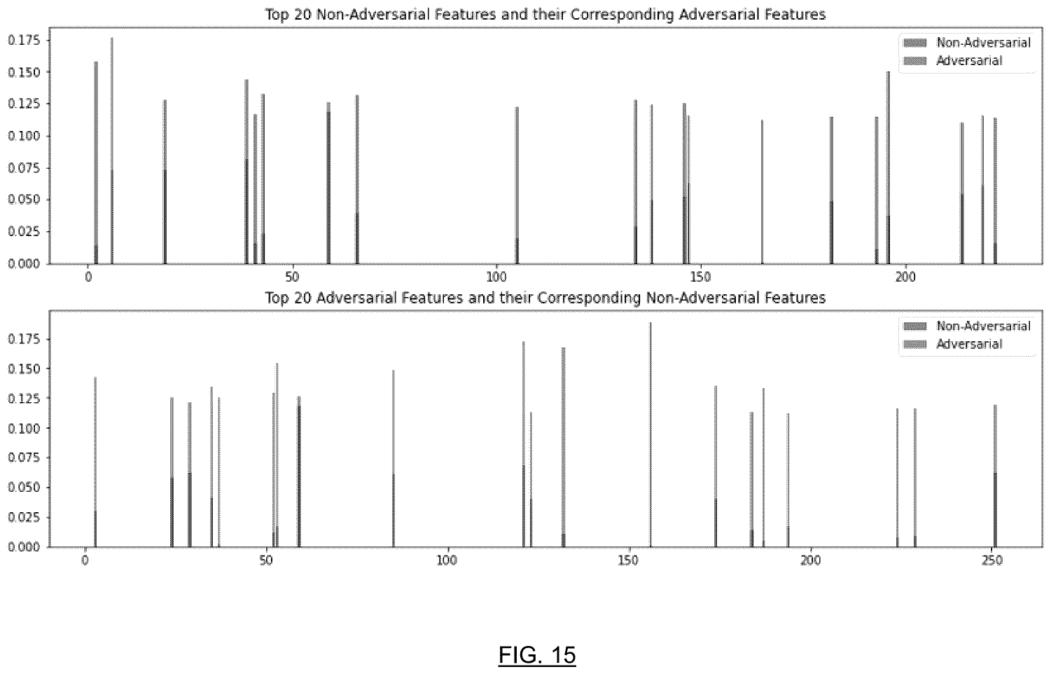

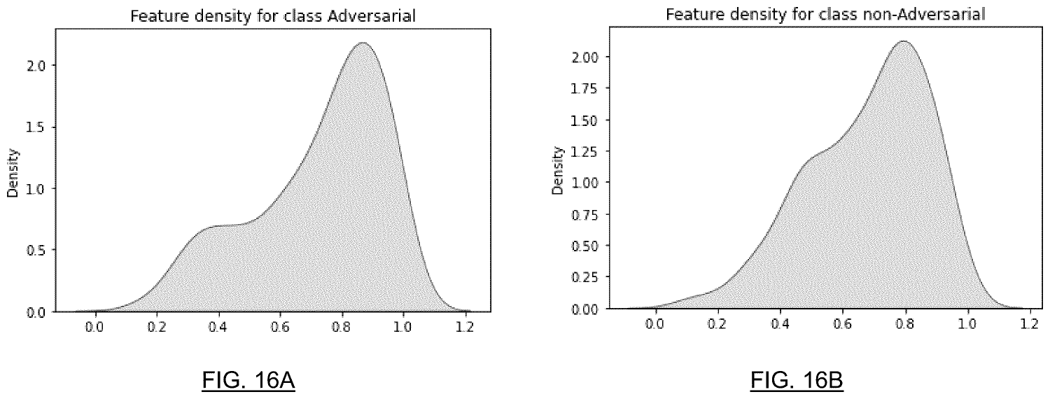

The incoming IoT executable files can be assessed based on the density of their salient features in relation to their PCA values; which are generated using PCA. The density distribution of these features can be visualized utilizing MMD, thus enabling the differentiation between adversarial and non-adversarial samples. This differentiation is visually represented in the example of FIG. 15, which shows adversarial and non-adversarial feature analysis using MMD. FIGS. 16A and 16B illustrate an example of one prominent feature class that PCA cannot differentiate but MMD can differentiate.

Usage of MMD to analyze the density distribution of the top feature components of adversarial and non-adversarial executable files advantageously enables the identification of the most prominent features. These features could either be adversarial or non-adversarial, and they can be employed in the detection of adversarial attacks on IoT devices. This approach can facilitate the detection of subtle variations between adversarial and non-adversarial samples. These variations generally will not have been readily identified by other approaches. Hence, the application of MMD in the present embodiments presents an efficacious approach to detect adversarial attacks on IoT devices. This significantly enhances the reliability and security of such devices, offering a substantial advancement in the field.

MDD is a statistical approach for assessing data distribution. In an example, MDD can be used after PCA scoring to detect adversarial samples based on their feature density. PCA gives a score to each feature of the incoming sample; then this feature score, and MDD, in combination, can be used for flagging adversarial samples using the stack of ML engines.

After extracting effective components (k, p) of each legitimate sample and adversarial sample, the adversarial prevention module 122 can use a stack of machine learning models, at block 410, to determine whether an incoming sample is adversarial. The training of the stack can be based on inputs comprising the MDD and PCA scores of both non-adversarial and adversarial sample datasets. The stack of machine learning models can be trained based on an extracted characteristic as a boosting method.

Using the present embodiments, example experiments were performed using a generated dataset of executable samples; which were produced by the generative component. As part of the training protocol for the Convolutional Neural Network (CNN) model, the initial set of principal components, which were the output of Principal Component Analysis (PCA), were used. The example experiments used binary classification to categorize the samples into adversarial and non-adversarial groups.

The architecture of the Malconv, which encompasses a convolutional neural network to derive features from the unprocessed binary data, served as a basis for the CNN model used in the experiments. The architecture included several convolutional layers, followed by a fully connected layer, and culminating with a sigmoid layer. The CNN model was trained using the dataset that was not subjected to the PCA dimensionality reduction. The model's performance was subsequently gauged using the test dataset. The PCA values associated with the incoming samples were primarily used for the detection of adversarial attacks on machine learning models. In this way, the PCA can be used to decrease the data dimensionality while preserving pivotal information. The PCA is applied to the incoming samples to detect and highlight the most significant features that can be categorized as adversarial or non-adversarial. The resultant PCA values for both adversarial and non-adversarial samples are displayed in FIG. 15. FIG. 15 illustrates the PCA values for the dataset samples, represented by divergent bar charts for the adversarial and non-adversarial samples.

In some cases, the stack of ML models can be validated the incoming sample such that each incoming sample bytecode by determining whether a majority of the classifiers in the stack determine the sample is adversarial or non-adversarial. In some cases, this determination can be based on a generated degree of confidence assigned to the given label (e.g., p>0.5). In some cases, the feature vector characteristic of adversarial samples can be stored as adversarial or non-adversarial.

While the present disclosure describes a machine learning stack, it is understood that any suitable machine learning approach can be used. In a particular case, the stack of machine learning models can use a three different ML model structure; for example, comprising a convolutional neural network, a decision tree model, and a k-nearest neighbors model, for classifying as adversaria based on an input feature vector. The stacking approach of ensemble learning can be used to avoid bias and to decrease false positives. Stacking can be advantageous because it can provide unbiased and explainable decisions. Using different types of classifiers in the stack allows for validation of generated adversarial examples for both deep and non-deep models. In this way, it can also cover different kinds of target models. Coordination of the stack can be accomplished with an integration function. For example, for each incoming sample, the integration function can determine a degree of confidence of each model in the stack and output a classification based on a given threshold of confidence.

In some cases, the adversarial malware prevention approach can be updated by defining new firewall rules or modifying current rules in its knowledge-based database. New firewall rules can be based on the adversarial dataset sample that was created by the generative model and validated against incoming adversarial samples. These rules can be defined and/or tuned by existing adversarial feature characteristics or raw feature vectors. Process costs can be sufficiently reduced by checking incoming sample features against an existing knowledgebase.

At block 412, once the output decision is determined for an incoming sample, the adversarial prevention module 122 can locate other instances of these adversarial features/signatures in incoming executable data. Additionally, at block 414, once the adversarial sample is detected, the feature characteristic (i.e., signature) of such adversarial sample, which is each sample with corresponding prominent flipper component, can be stored in a signatures database for evaluating any forthcoming samples.

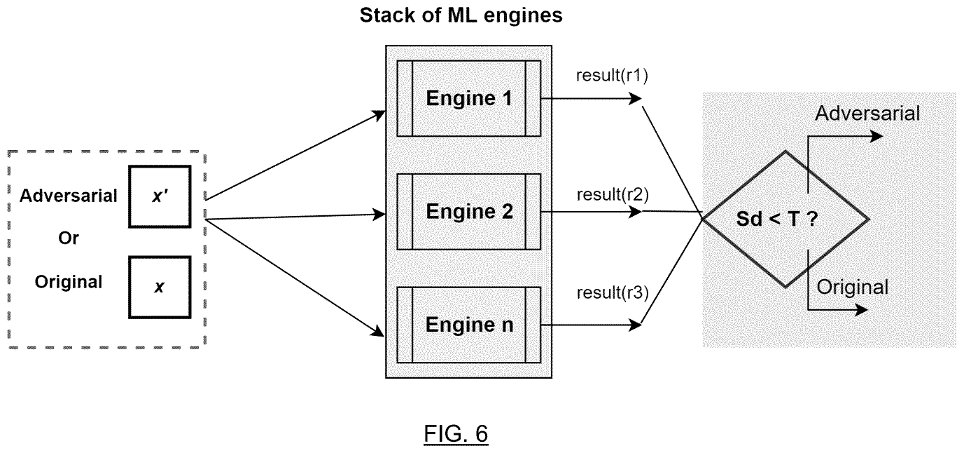

FIG. 6 illustrates a diagram of an example of decision making of the adversarial prevention module 122, which includes:

```
Let M be the classifier in the stack of n learners and p be the
probability of an assigned label for an incoming sample, then:
  Set T >0.5; Where T is the aggregation threshold.
  M = M₁, M₂, . . . , Mₙ
  if Mᵢ (x) = pᵢ,
  $P = \frac{1}{n} {\sum }_{i = 1}^{n} {M}_{i} ( x )$
  if P > T then:
    x is adversarial;
    drop x.
  else:
    pass x.
```

The above algorithm defines a decision-making approach for a stack of ML models when provided with an input x; which is the incoming sample feature vector characteristic. Each model classifies the incoming sample based on their trained engine M(x) and assigns a label associated with a degree of confidence p (probability). If the mean aggregated probability is above a defined threshold (‘T’), then the incoming sample is classified as adversarial and is dropped. Otherwise, the sample is passed on to other aspects in the computing environment; for example, passed to other defensive mechanisms, such as a malware threat hunting engine.

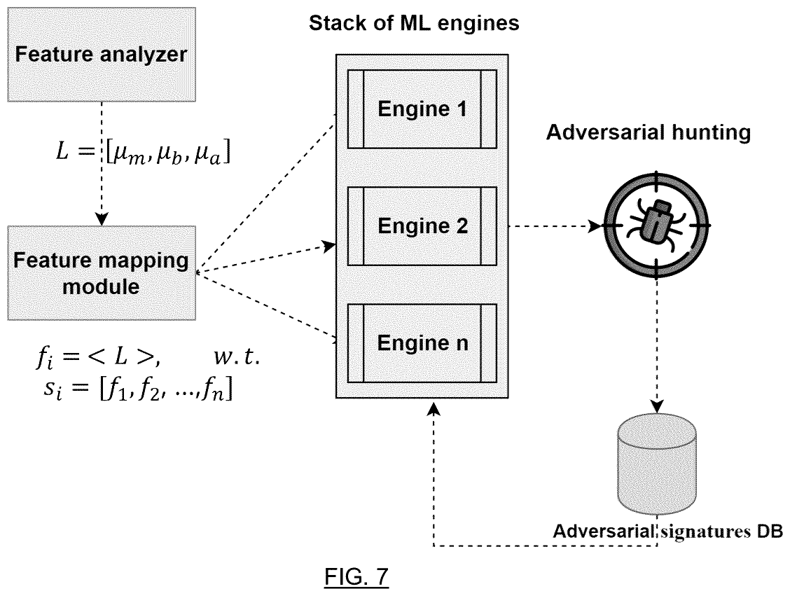

FIG. 7 illustrates an example of the stack of ML engines aggregating an output decision on an incoming sample.

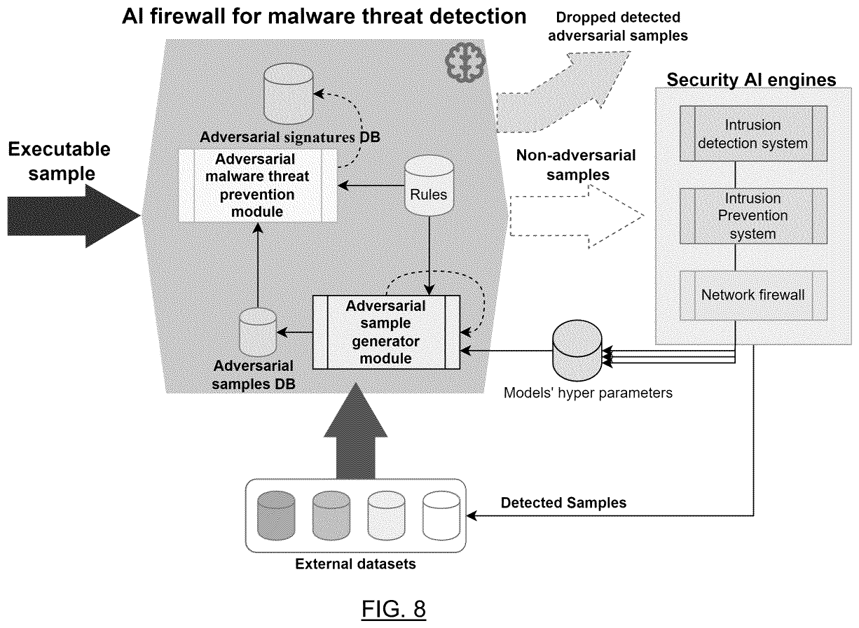

FIG. 8 illustrates an example diagram of an implementation of a firewall for malware threat detection, in accordance with the present embodiments. An executable sample is received by the input module 118. The adversarial prevention module 122 takes such input sample and determines whether the sample is likely adversarial. As described herein, the adversarial prevention module 122 uses rules and adversarial samples generated by the sample generator module 120 to determine if the sample is adversarial. If the determination is adversarial, the sample will be dropped (i.e., not delivered to the AI engine); whereas if the determination is non-adversarial, the sample is delivered to the AI engine. The sample generator module 120 generates the samples using model hyper parameters of the AI engine and datasets of detected samples.

The presently disclosed embodiments can be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

1. A computer-executed method for adversarial malware threat prevention, the method comprising:
receiving an input executable sample;
extracting features of the input executable sample and applying feature mapping to determine one or more components of the features;
determining a binary classifier representing whether the executable sample is adversarial using one or more machine learning models, the one or more machine learning models taking the one or more components as input, the one or more machine learning models trained using, at least, generated adversarial samples, wherein generating the generated adversarial samples comprises determining code caves in training executable samples and inserting generated payloads as benign samples at the determined code caves; and
where the binary classifier indicates adversarial, dropping the input executable sample, otherwise outputting the input executable sample.

2. The method of claim 1, wherein the binary classifier classifies the executable sample where a probability of being adversarial is above a defined threshold.

3. The method of claim 2, wherein the one or more machine learning models comprises a stack of machine learning models and wherein the probability of being adversarial is an aggregated probability of the outputs of the machine learning models in the stack of machine learning models.

4. The method of claim 2, wherein the defined threshold is a probability greater than 0.5.

5. The method of claim 1, further comprising receiving a further input executable sample and, where the input executable sample was determining to the adversarial, comparing the input executable sample to the further input executable sample to determine if the further input executable sample is adversarial.

6. The method of claim 1, wherein determining the one or more components of the features comprises scoring features and determining a most prominent feature, and using the one or more components of the most prominent feature.

7. The method of claim 1, wherein determining the one or more components of the features comprises performing principal component analysis.

8. A system for adversarial malware threat prevention, the system comprising one or more processors and a data storage, the data storage comprising instructions for the one or more processors to execute:
an input module to receive an input executable sample;
an adversarial prevention module to extract features of the input executable sample and apply feature mapping to determine one or more components of the features, and to determine a binary classifier representing whether the executable sample is adversarial using one or more machine learning models, the one or more machine learning models taking the one or more components as input, the one or more machine learning models trained using, at least, generated adversarial samples, wherein generating the generated adversarial samples comprises determining code caves in training executable samples and inserting generated payloads as benign samples at the determined code caves; and
an output module to output the input executable sample unless the binary classifier indicates adversarial.

9. The system of claim 8, wherein the binary classifier classifies the executable sample where a probability of being adversarial is above a defined threshold.

10. The system of claim 9, wherein the one or more machine learning models comprises a stack of machine learning models and wherein the probability of being adversarial is an aggregated probability of the outputs of the machine learning models in the stack of machine learning models.

11. The system of claim 8, wherein the input module receives a further input executable sample and, where the input executable sample was determining to the adversarial, the adversarial prevention module compares the input executable sample to the further input executable sample to determine if the further input executable sample is adversarial.

12. The system of claim 8, wherein determining the one or more components of the features comprises scoring features and determining a most prominent feature, and using the one or more components of the most prominent feature.

13. The system of claim 8, wherein determining the one or more components of the features comprises performing principal component analysis.

14. A computer-executed method for adversarial sample generation, the method comprising:
receiving an executable sample;
generating executable segments from the executable sample;
determining one or more code caves as sparse spaces in the executable segments;
generating payloads based on patterns in the executable segments;
inserting the payloads into at least one of the code caves of the executable sample;
outputting the executable sample with the inserted payloads.

15. The method of claim 14, wherein generating the executable segments comprises performing a chunking function.

16. The method of claim 14, wherein the executable segments are in bytecode.

17. The method of claim 16, wherein generating the payloads comprises inputting the executable segments into a generative machine learning model, the generative machine learning model trained using bytecode segments of malicious and benign samples.

18. The method of claim 17, wherein the executable segments substantially comprise ‘.data’ segments.

19. The method of claim 17, further comprising iteratively performing receiving the executable sample, generating the executable segments, determining the one or more code caves, generating the payloads, and inserting the payloads, wherein the payloads are inserted in different code caves than those that received payloads in a previous iteration.

20. The method of claim 14, wherein determining the one or more code caves comprises sparse spaces that are greater than a predetermined size.
